(19) United States
(12) Patent Application Publication
(10) Pub. No.: US 2019/0012715 A1
(43) Pub. Date: Jan. 10, 2019

(54) SEARCHING FOR ITEMS BASED ON PEER RANKING OF QUALITY

(71) Applicant: Wymp, Inc., Fremont, CA (US)

(72) Inventors: Valentine Lan, Fremont, CA (US); Johnny Dara Neang, Union City, CA (US); Brett S. Millar, San Mateo, CA (US); Long Liang, San Lorenzo, CA (US)

(21) Appl. No.: 16/056,272

(22) Filed: Aug. 6, 2018

Related U.S. Application Data
(63) Continuation-in-part of application No. 14/743,314, filed on Jun. 18, 2015, now abandoned.

(51) Int. Cl. G06Q 30/06; G06F 17/30

(52) U.S. Cl. CPC G06Q 30/0625; G06F 17/30867; G06F 17/30377; G06F 17/3087; G06F 17/3053

(57) ABSTRACT

A server receives a request from a first application to search for retail availability of a specific item near a defined location. The defined location may be provided by the user, of determined by the server. The server performs a search for the specific item in a database storing data records for a plurality of items, wherein the data records are populated by users of the first application. Each data record includes a unique identifier, an item type, a item sub-type, an item description, a retail outlet where the item is available, and the number of likes for the item at particular retail outlets, as posted by other users for the item at the retail outlet. The server generates search results as a list of different retail outlets ranked in descending order by the number of likes for the specific item at those different retail outlets.

### CROSS-REFERENCE

This application is a continuation-in-part of U.S. application Ser. No. 14/743,314 filed Jun. 18, 2015, entitled System and Method for Searching for Specific Types of Items Based on Peer Ranking of Quality, the entirety of which is incorporated herein by reference.

### TECHNICAL FIELD

This disclosure relates generally to electronic searching for information, and more particularly, to systems and methods for searching for specific types of items on the basis of peer rankings of item quality.

### BACKGROUND

The Internet is a system of interconnected computer networks that stores vast amounts of information, and is easily accessed by computer-based devices, such as desktop computers, laptops, smartphones, etc. Current search engines, such as Google, Firefox, Edge, Safari, etc., are limited in their ability to find a specific type of item based on the user's search terms and preferences. Specifically, several web-based and mobile application search engines currently exist that allow users to type in a specific search term (word or phrase) and obtain search results based on the most common uses of the typed word or phrase. The general purpose of these lists is to provide users with choices of where to buy, how to use, or the background of the searched item. Similarly, there are existing web-based and mobile application ranking services where a user can search for a specific product or service that ranks the entities selling the product or service based on various parameters relating to the overall experience of other users such as service, pricing, ambiance and popularity of the product or service being searched.

None of the current search engines or ranking services are focused solely on ranking the popularity of a specific item being searched for based upon the opinions of other users. For example, if a user is traveling and decides to look for a specific food dish to eat, using any of the current search engines, the search would result in a list which would likely include recipes about how to make that food dish, the origin of that food, and articles and links to opinions rendered by a magazine, independent reviewers' or bloggers as to the best place to purchase that food dish in the particular city or location. Likewise, if a user typed that food dish into one of the existing ranking services, the search would result in a list of entities selling that food item based on the overall user experience where the popularity and quality of the specific food dish is only one of the factors in the resulting overall entity ranking.

### BRIEF DESCRIPTION OF THE DRAWINGS

FIG. 1 is a block diagram illustrating a system for searching for specific types of items based on peer ranking of quality.

FIG. 2 is a block diagram illustrating the components of one of the computer-based user devices of FIG. 1.

FIG. 3 is a block diagram illustrating the components of the server of FIG. 1.

FIG. 4 is a table illustrating one embodiment of data records that are stored in the database of FIG. 1.

FIG. 5 is a table illustrating another embodiment of data records that are stored in the database of FIG. 1.

FIG. 6A is a flow chart illustrating a basic process implemented on a user device for searching for a specific type of item at a desired location.

FIG. 6B is a flow chart illustrating an alternative basic process implemented on a user device for searching for a specific type of item without specifying a desired location.

FIG. 6C is a flow chart illustrating an alternative basic process implemented on a user device for searching for an item based on the desired location.

FIG. 7A is a flow chart illustrating a basic process implemented on a server for searching for specific types of items.

FIG. 7B is a flow chart illustrating an alternative basic process implemented on a server for searching for specific types of items.

FIGS. 8A and 8B are flow charts illustrating a detailed process of interaction between a desktop user device and a server for searching for specific types of items.

FIG. 9 depicts a landing page displayed on a user device.

FIG. 10 depicts a search page displayed on a user device.

FIG. 11 is a flow chart illustrating a detailed process of interaction between a mobile user device and a server for searching for specific types of items.

FIG. 12 illustrates a login screen for a mobile user device.

FIG. 13 is a flow chart illustrating a process for users to post a like for an item.

FIG. 14 is a flow chart for enabling users to post a like for an item.

FIG. 15A depicts a search page display on a user device, and FIG. 15B depicts an options menu overlayed on the search page display.

### DETAILED DESCRIPTION

This disclosure provides examples of systems and methods for quickly and easily finding a particular item that is ranked as most popular among peers at retail outlets within a defined local area. The examples and descriptions thereof should not be considered limiting but are merely illustrative of possible embodiments of the systems and methods.

In general, the systems and methods can be implemented as a server-hosted service accessible from any computer-based device, such as a smartphone, tablet, laptop computer, desktop computer, etc. Standard communication protocols may be used for both wired and wireless communication links among the computer-based devices, including the use of browser programs and mobile applications to interact with server-based applications, services and data. For example, a service entitled What's Your Most Popular has been created to implement the systems and methods described herein, hosted on a server that is accessible at the URL: https://www.wymp.co/login.

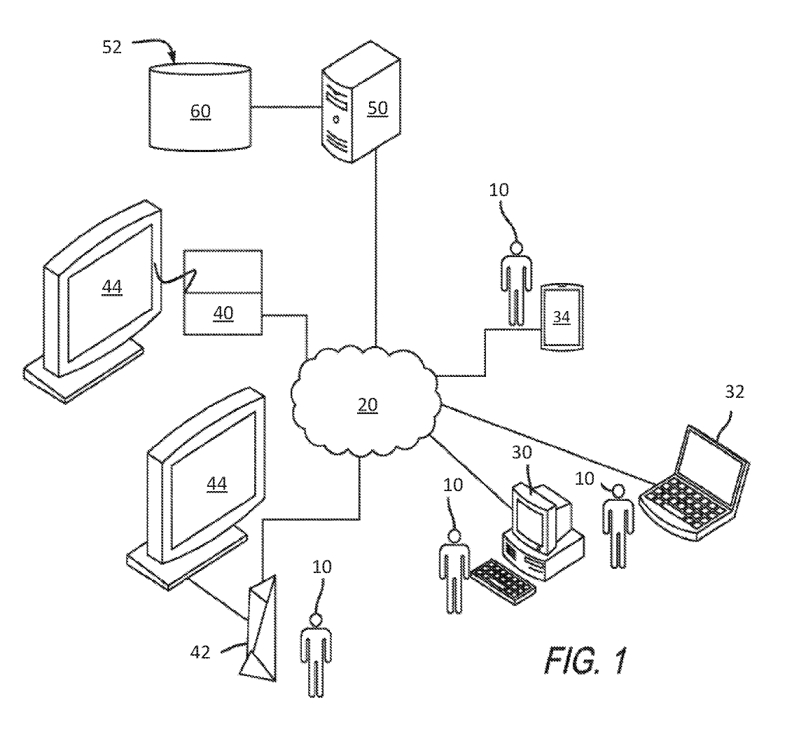

With reference to FIG. 1, an exemplary Internet-based system is shown. A number of different users 10 are connected to a network 20, such as the Internet, via a variety of different types of computer-based platforms, including desktop computer 30, laptop computer 32, smartphone 34, etc., all of which include integrated user displays. Interconnections and communications protocols among the various devices and networks are conventional. Other modes of accessing the Internet are possible, including for example, an internet protocol television (“IPTV”) 40 and a video game console 42, each of which is coupled to a television monitor 44 in order to display content, and each of which includes communications software configured for connecting to the Internet. Popular game consoles include Microsoft XBOX consoles, Sony Playstation consoles, Nintendo consoles such as the Wii console, etc. All computer-based devices typically include local storage for data and applications and one or more processors configured for running the applications, communicating with the Internet and other computer-based devices, and performing various computing tasks.

One or more servers 50 are accessible through the Internet 20 for hosting various services and applications, including the search engine service described herein. The server 50 typically includes some limited storage capability, as well as access to remote storage 52, which may be configured to define one or more databases 60 as further described herein.

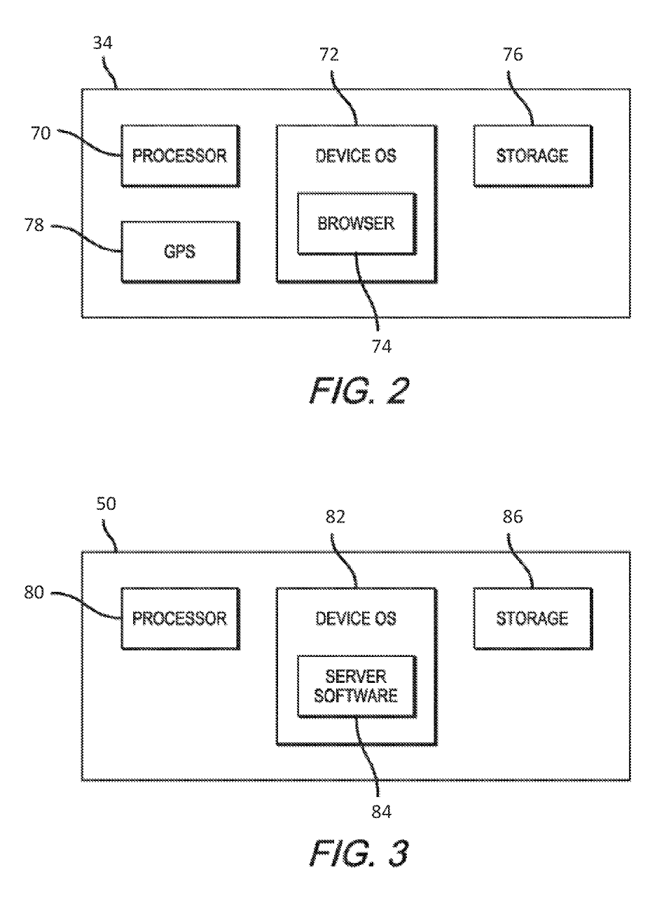

FIG. 2 illustrates the internal components of a typical user device such as smartphone 34. The other computer-based devices shown in FIG. 1 have a similar structure. As those skilled in the art would recognize, the user device 34 includes a processor 70 and an operating system (“OS”) 72. A browser program 74 is compatible with OS 72 for executing instructions that allow the device 34 to interact with the Internet 20 and other devices. The user device 34 includes at least random access memory (“RAM”) 76, which is used as a working memory for quick read and write access to storage devices, including loading programs (such as the browser application 74) and storing program data. Further, the user device 34 may include a geographic positioning system (“GPS”) 78, which is typically installed on any mobile computer-based device.

Referring to FIG. 3, the internal components of the server 50 are illustrated. As those skilled in the art would recognize, the server 50 includes a processor 80 and an operating system 82 that operates to execute instructions of the server software 84. The relevant computer program, such as a search engine for locating items on the basis of peer ranking of quality as described herein, may embody the server software 84, which can be loaded by the operating system 82 for running by the processor 80 on server 50. The server 50 may include local storage 86, but as shown on FIG. 1, the server also has access to database 60 configured in remote storage 52.

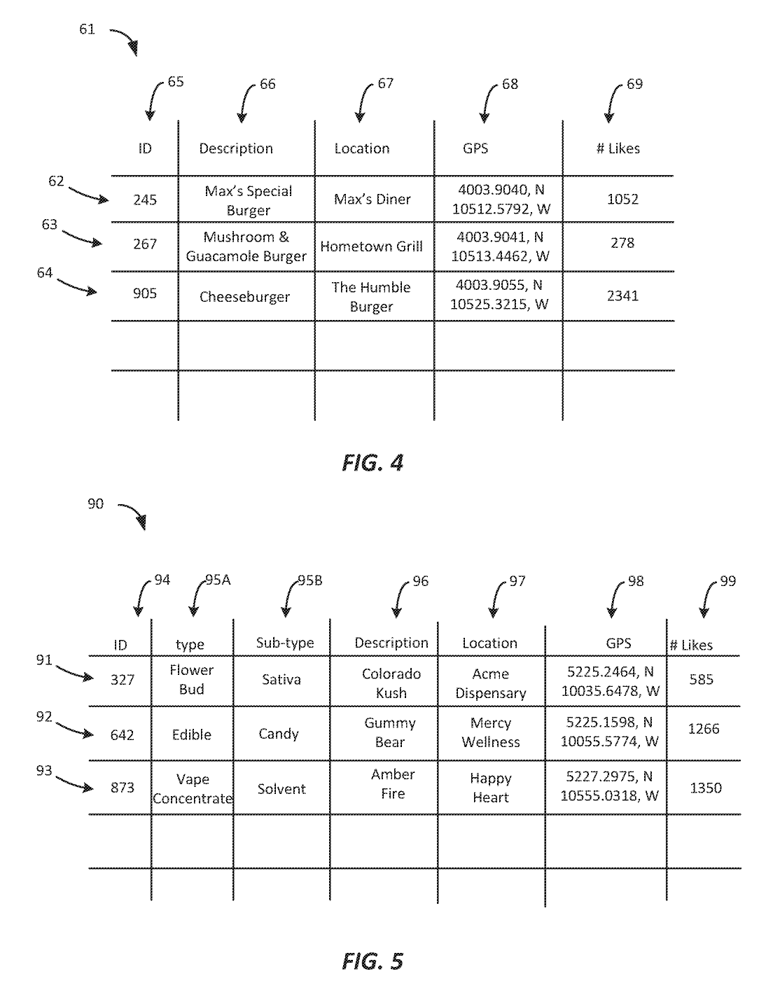

FIG. 4 illustrates one embodiment of the remote storage device 52 configured with database 60. In this embodiment, the server software 84 includes instructions that allow users 10 to execute an online search to locate the most popular food item(s) in a selected area, measured by peer rankings of quality, that meet the user's search criteria as further discussed below. For example, the database 60 may be configured with one or more tables storing relevant data about the food items including peer ratings of the quality of food items at various locations. Further, the data records of the database 60 are populated by users of the dedicated search engine application. The results of the online search are generated by performing the search against the database 60 and retrieving relevant results.

Table 61 of database 60 illustrates some of the data that may be stored for food items and related rating data. Each of the rows 62, 63, 64 of the table 61 is an individual data record, i.e., each row stores multiple pieces of information related to a single food item. Columns 65, 66, 67, 68, 69 are configured to store information for each of the single food items as follows: column 65 lists a numerical identifier for the food item; column 66 lists a description of the food item; column 67 lists a retail outlet that carries the food item; column 68 lists geolocation data, i.e., latitude and longitude derived from a global positioning system (“GPS”); and column 69 lists a value representing the number of likes received from users for the food item at the location. Of course, the table 61 could include many more rows, as well as other data, such as the address and telephone number of the retail outlet, hours of operation, whether the location takes reservations, etc.

In this example, the user searches for the most popular “burger” near the user's present location (or any other defined location), and at least rows 62-64 of table 61 contain information relevant to this query. Thus, row 62 stores information for a single food item having the unique identifier number 245 in column 65. The food item is described as “Max's Special Burger” in column 66. The retail outlet/restaurant offering the food item is listed as “Max's Diner” in column 67, and the GPS data for that outlet is listed in column 68. Finally, the number of likes for Max's Special Burger at Max's Diner is listed in column 69.

Row 63 stores information for a single food item having unique identifier number 267 in column 65. The food item is described as “Mushroom and Guacamole Burger” in column 66. The retail outlet offering the food item is listed as “The Hometown Grill” in column 67, and the GPS data for that outlet is listed in column 68. Finally, the number of likes for the Mushroom and Guacamole Burger at the Hometown Grill is listed in column 69.

Row 64 stores information for a single food item having unique identifier number 905 in column 65. The food item is described as “Cheeseburger” in column 66. The retail outlet offering the food item is listed as “The Humble Burger” in column 67, and the GPS data for the outlet is listed in column 68. Finally, the number of likes for the Cheeseburger at the Humble Burger is listed in column 69.

FIG. 5 illustrates another embodiment of the remote storage device 52 configured with database 60. In this embodiment, the server software 84 includes instructions for users 10 to execute an online search to locate the most popular cannabis item(s) near the user's present location (or other defined location), measured by peer rankings, that meet the user's search criteria, as further discussed below. For example, the database 60 may be configured with one or more tables storing relevant data about the cannabis items including peer ratings of the quality of cannabis items at various retail outlets. The results of the online search are generated by performing the search against the database 60 and then retrieving and ordering relevant results.

In this embodiment, table 90 of database 60 illustrates some of the data that may be stored for cannabis items and related rating data. Each of the row 91, 92, 93 of the table 90 is an individual data record having information related to a single cannabis item. Columns 94, 95A, 95B, 96, 97, 98, 99 are configured to store information for each of the single cannabis items as follows. Column 94 lists a unique numerical identifier for the cannabis item. Column 95A lists the type of cannabis item, e.g., flower buds, edible, or vape concentrate. At the present time, these are the primary and most popular types of cannabis products, although other types of products could be made and included. Column 95B lists the sub-type of cannabis item, e.g., flower buds could be indica, sativa or hybrid; edibles could include beverages, brownies, candies, etc.; vape concentrate could include extracts, such as hash, hash oil, honey oil, resin, dabs, tincture, etc. Column 96 lists a description of the cannabis item; column 97 lists a retail outlet selling the cannabis item; column 98 lists the geolocation for the retail outlet. Column 99 lists the number of likes received from users for the cannabis item at the location.

Row 91 stores information for a single cannabis item having the unique identifier number 327 in column 94. The type of cannabis item is listed as “flower bud” in column 95A. The sub-type of cannabis item is listed as “sativa” in column 95B. The cannabis item is described as “Colorado Kush” in column 96. The retail outlet selling the cannabis item is listed as “Acme Dispensary” in column 97, and the geolocation for the Acme Dispensary is listed in column 98. Finally, the number of likes for the Colorado Kush sativa flower bud at the Acme Dispensary is listed in column 99.

Row 92 stores information for a single cannabis item having unique identifier number 642 in column 94. The type of cannabis item is listed as “edible” in column 95A. The sub-type of cannabis item is listed as “candy” in column 95A. The cannabis item is described as “Gummy Bear” in column 96. The retail outlet offering the cannabis item is listed as “Mercy Wellness” in column 97, and the geolocation data for the retail outlet is listed in column 98. Finally, the number of likes for the Gummy Bear edible candy at Mercy Wellness is listed in column 99.

Row 93 stores information for a single cannabis item having unique identifier number 873 in column 94. The type of cannabis item is listed as “vape concentrate” in column 95A. The sub-type of cannabis item is listed as “solvent” in column 95B. The cannabis item is described as “Amber Fire” in column 96. The retail outlet offering the cannabis item is listed as “Happy Heart” in column 97, and the geolocation for the retail outlet is listed in column 98. Finally, the number of likes for Amber Fire solvent vape concentrate at the Happy Heart is listed in column 99.

Thus, an item-specific database can be populated with data related to that specific item, and in preferred applications, the database data is only related to that specific item. For example, as described herein, in one embodiment the database is populated with food items, while in another embodiment the database is populated with cannabis item. Further, there are three potential search strategies that the user can employ to search an item-specific database: search based on the item only; search based on the location only; or search based on both item and location.

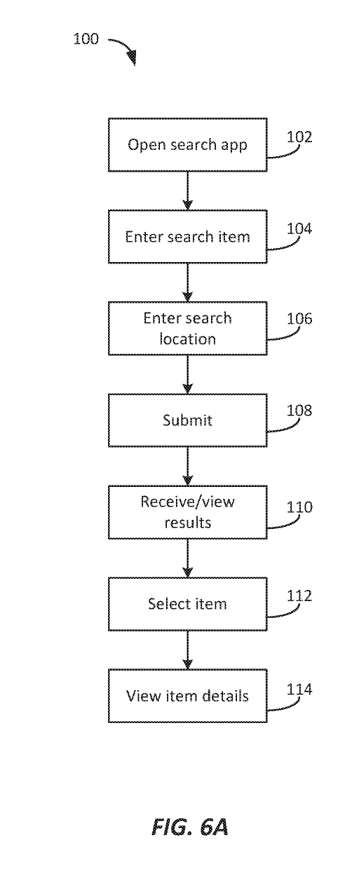

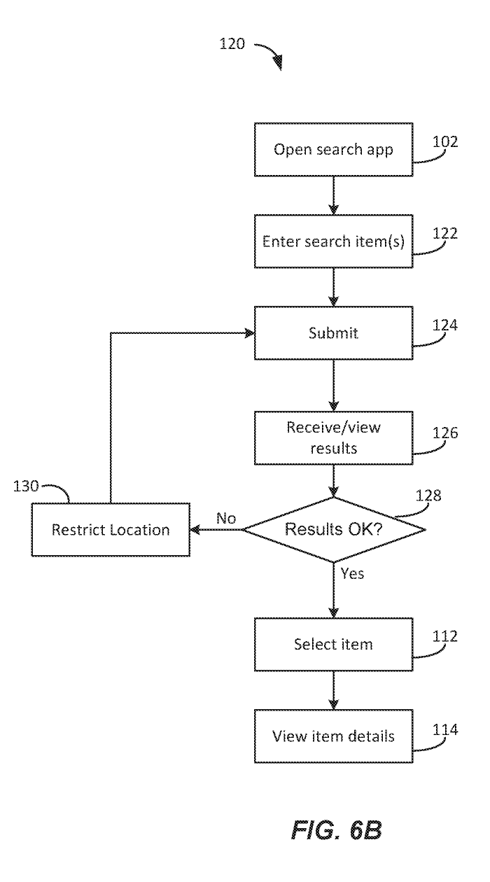

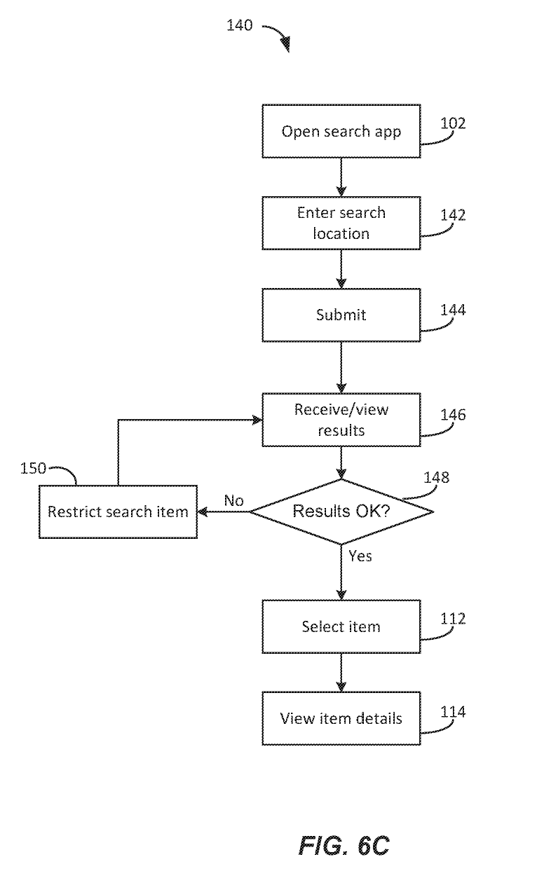

In FIG. 6A, a simple generalized user process 100 is illustrated for searching for a specific item, such as a food item, a cannabis item, or virtually any other item, on the basis of quality ranking by peers of the specific item at different retail outlets in a desired local area. In step 102, the user opens the search application installed on the user device and is presented with a screen or page having a first field for entering one or more search terms and a second field for entering a location. In step 104, the user enters a desired item into the search field. In step 106, the user enters a desired location into the location field.

In step 108, the user submits the search request having both the desired item and the desired location, which are transmitted to the search engine hosted on the server. In step 110, the user device receives the search results generated by the server and displays the results on the user device. The search results are listed in an order according to the peer rankings of quality, for example, a list of the top ten peer rated items, within a set distance of the defined location. In step 112, the user selects one of the items from the results list. In step 114, the user views relevant information about the selected item that is also generated by the server from the database, such as directions to the location, contact information for the location, a link to make a reservation at a restaurant location identified in the search, etc.

In FIG. 6B, a similar but alternative user process 120 is illustrated with an initial focus on the item rather than the location. In step 102, as before, the user opens the search application and is presented with a first field for the search terms and a second field for the location. In step 122, however, the user enters a desired item into the search item field, but leaves the location field blank. In 124, the user submits the search request, which only includes the desired item, to the search engine. In step 126, the user device receives and views the search results generated by the search engine, which lists desired items and retail outlets offering the desired items. If the results are adequate for the user's needs in step 128, then as in process 100, the user selects an item from the results list in step 112, and views relevant information about the selected item in step 114. If the results are not adequate for the user's needs in step 128, then the user can modify the search criteria to restrict the search results by location in step 130, and resubmit the modified search request in step 124.

In FIG. 6C, another alternative user process 140 is illustrated with an initial focus on the location rather than the item. Once again, the user opens the search application in step 102 and is presented with the search field and the location field. In step 142, however, the user enters a desired location into the search location field, but leaves the item field blank. In 144, the user submits the search request, which in this scenario only includes the desired location. In step 146, the user device receives and views the search results generated by the search engine, which include all types of the items stored in the item-specific database near the desired location. If the results are adequate for the user's needs in step 148, then as in processes 100 and 120, the user selects an item from the results list in step 112 and views relevant information about the selected item in step 114. If the results are not adequate for the user's needs in step 148, the user can modify the search criteria to restrict the search results by item type or sub-type in step 150, and resubmit the modified search request in step 144.

In one embodiment, when the user is interested in items that are available near the user's present location, the user need not enter the desired location. Instead, the server can determine the user's location directly from the user's device and impose a range or distance limitation from the location, for example, as a default setting. In one embodiment, the server imposes a default range of 0.3 miles from the user location, which is a logical distance in a high-density urban area. However, the default range could be set to a different distance, or the user could set the range or be asked by the server to set the range or select a range from a list of possible ranges.

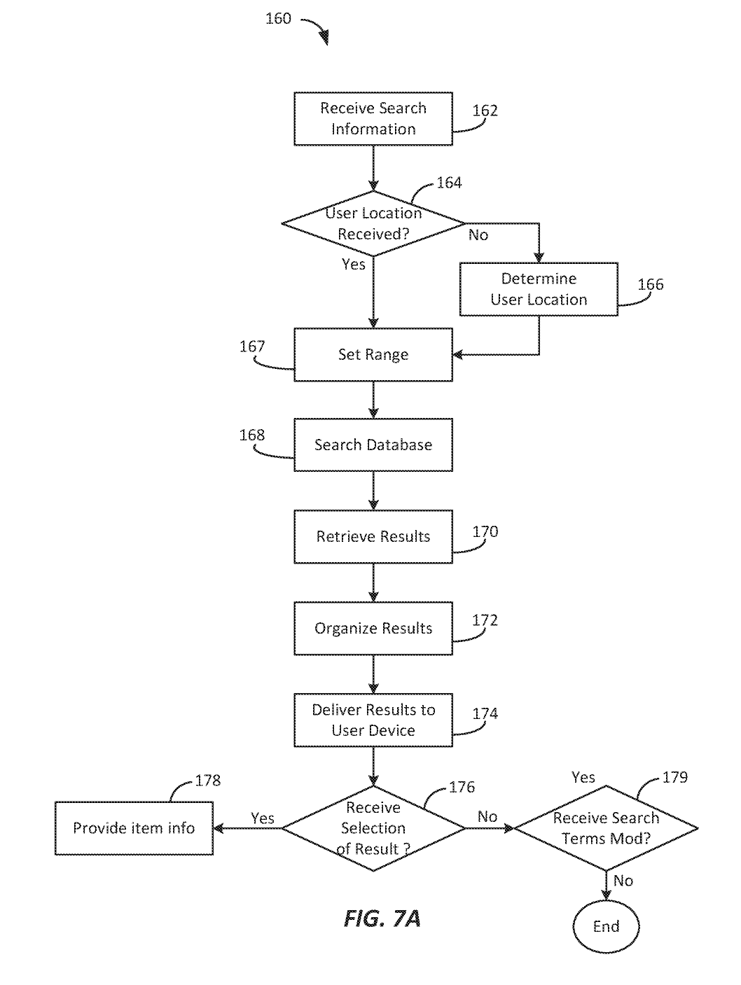

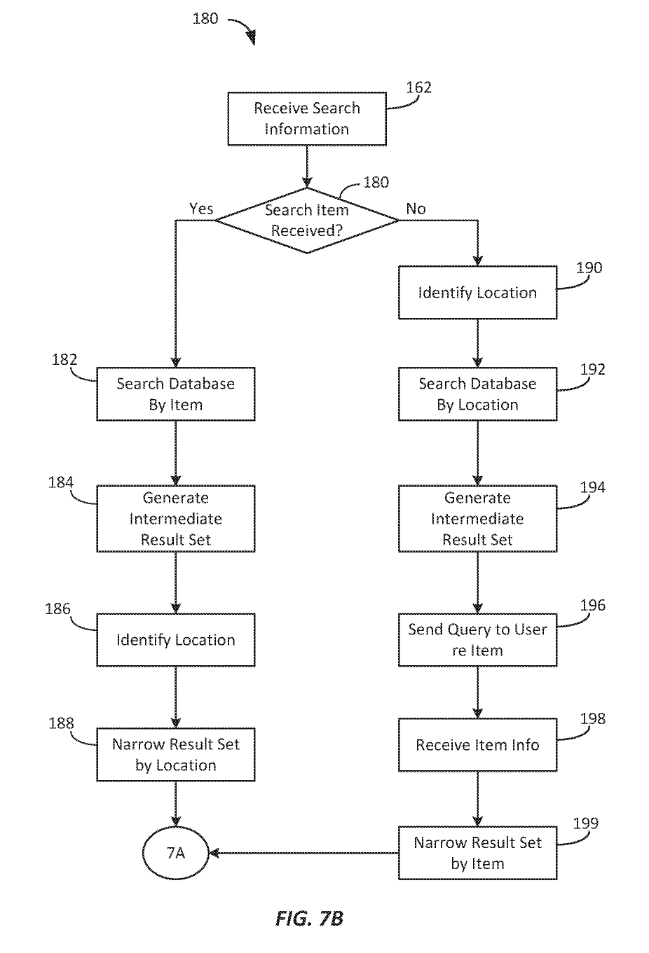

Referring now to FIG. 7A, a simple generalized server process 160 corresponding to the user process 100 is illustrated. In step 162, the server receives search information from the search application installed on a user device, which may include either or both of a search item and a search location. In step 164, the server determines whether a location has been received from the user device. If not, then in step 166, the server determines the location of the user device, for example, from the IP address of the device, which is inherently part of the data packet sent from the user device to the server, or from geolocation data on a mobile device, if the device is location enabled.

Once the location is determined in step 166, or if the location was received from the user in step 164, then the server sets a range from the location in step 167 in order to restrict the distance from the location for the search. The range may be a default setting, such as 0.3 miles, or may be entered or selected by the user. In step 168, the server searches the database using both the search item and the search location. Results from the search, namely, records in the database that meet the search criteria, are retrieved in step 160. In step 162, the results are organized into an ordered listing on the basis of peer rankings, namely, with the highest ranked (most popular) items listed first. In step 174, the ordered results are transmitted to the user device for display of the results to the user.

If the server detects in step 176 that the user has selected one of listed results, then in step 178, the server generates additional information regarding the selection and transmits the additional information to the user device. For example, the additional information may be directions to the location having the most popular item, contact information for the location, etc. However, if the user has not selected one of the listed results in step 176, then the server determines in step 179 whether the user is submitting modified search terms. If so, the modified search term is submitted again to search the database in step 168, For example, if the user submitted a search item only, and the results were inadequate, then the user can add a location restriction. If the user submitted a search location only, and the results were inadequate, then the user can add an item restriction, such as type or sub-type.

A variation of the server process 160 is illustrated in FIG. 7B as process 180 for performing some of the search steps. In this embodiment, only one or the other of the search item and the search location are provided by the user and received by the server. Step 162 remains the same—the server receives search information from the user device. In step 180, the server determines whether a search item is identified by the user. If so, in step 182 the server searches the database for the item and returns an intermediate result set in step 184. In step 186, the search location is identified. The search location may be identified by the user in response to a subsequent query from the server, or may be determined exclusively by the server, for example, by reference to the IP address of the user device or by reference to geolocation data of the user device. In step 188, the intermediate result set is narrowed by applying the location information to reduce the number relevant search results. Finally, the process 180 returns to step 172 of process 160 (see FIG. 7A) to organize the results and deliver results to the user.

If a search item is not identified by the user in step 180, then the user must have provided a search location, and that location is identified in step 190. In step 192, the server searches the database for the location (recall that the database is item specific) and generates an intermediate result set in step 194. In step 196, the server sends a query to the user device asking for more specific item information. In step 198, the server receives more specific item information from the user, and narrows the intermediate result set by applying item location information to reduce the number relevant search results in step 199. The process 180 returns to step 172 of process 160 (see FIG. 7A) to organize the results and deliver results to the user.

Accessing and Using the System from a PC and System Website

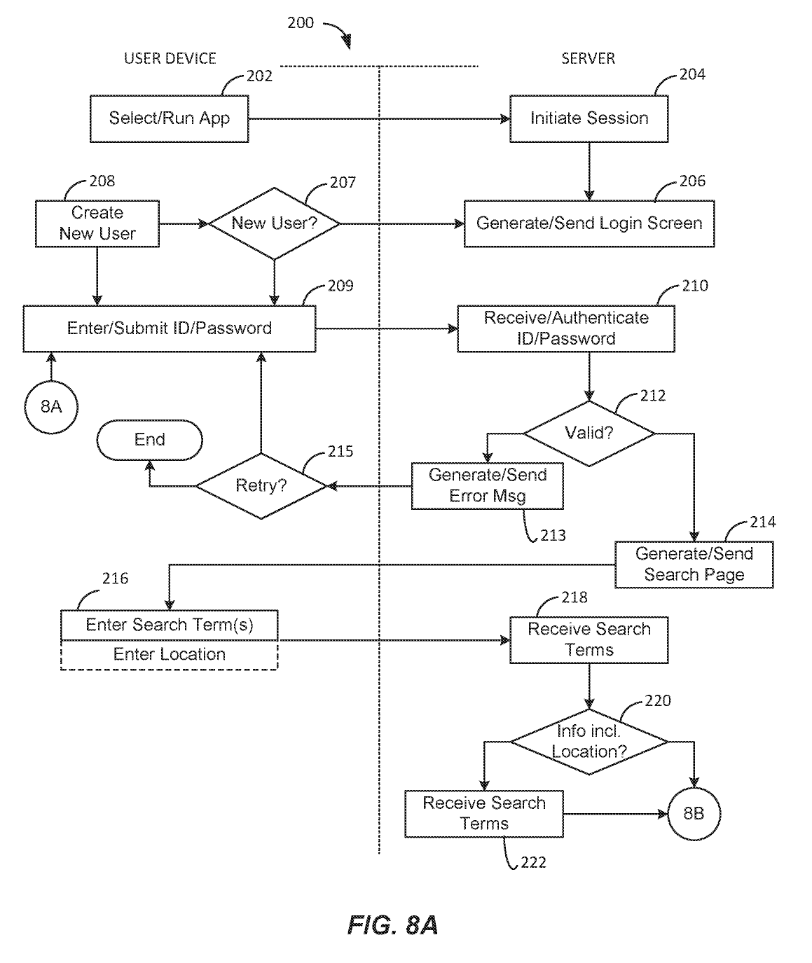

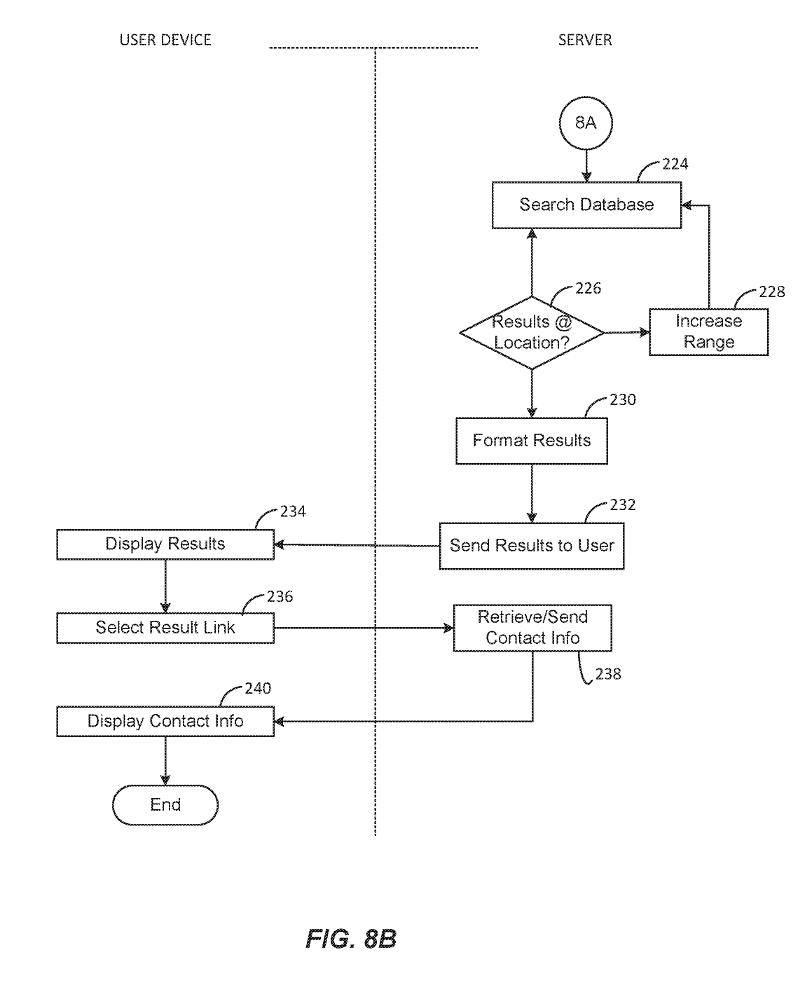

Referring to FIGS. 8A and 8B, a detailed process 200 is illustrated for accessing the search engine hosted on server 50 from a desktop computer 30 via the Internet 20. Although some of the process steps must be performed in a certain order, other steps (such as detecting the location of the user device) may be performed in a different order without departing from the scope of this disclosure. The desktop computer 30 may be a conventional computer-based device having its operation managed by an operating system, such as the Linux OS, the Windows OS, the MAC OS, or other equivalent OS.

In step 202, the user selects and runs a dedicated search engine application that has a client portion installed on the desktop and is built for item searching in a specified location based on peer ranked quality, as described herein. Running the search engine application causes the desktop to contact the server using standard communication protocols and initiate a server session with the server portion of the search engine application in step 204.

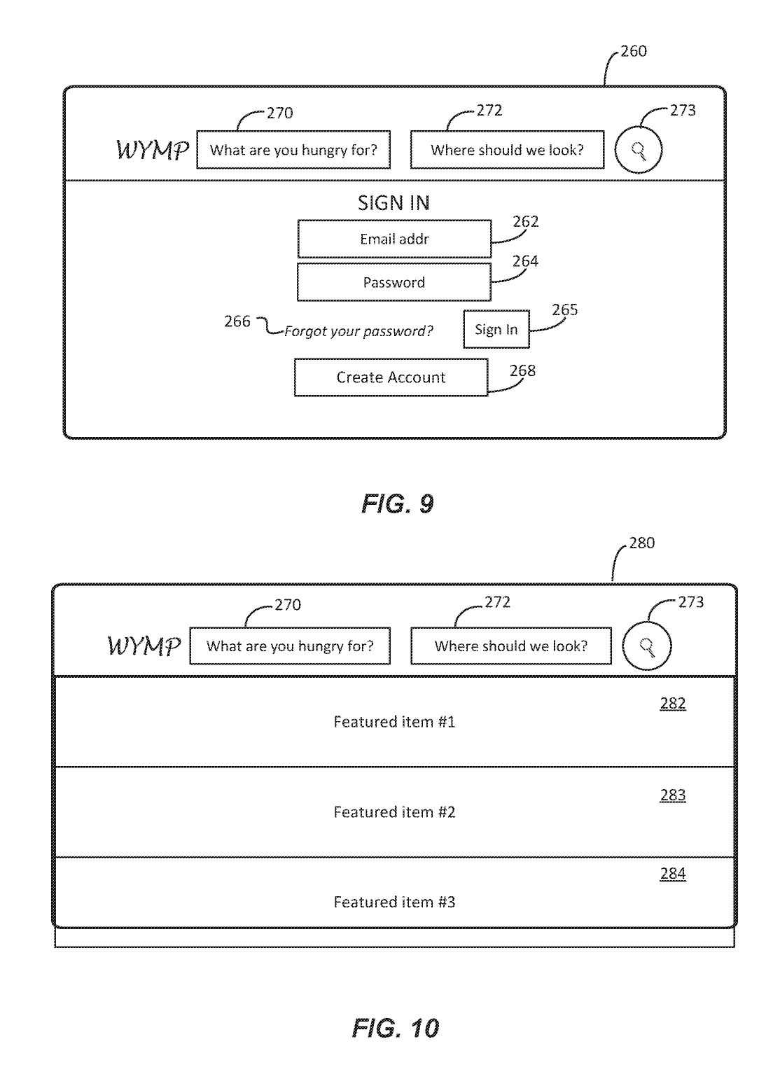

In step 206, the server generates a landing page and sends it to the user device. In one embodiment, illustrated in FIG. 9, the landing page 260 includes a pair of widgets 262, 264 configured as data entry fields for providing log-in information, and a widget 265 configured as a selectable button (“Sign In”) for submitting the log-in information once entered by the user into the data fields. The page 260 also includes a widget 266 configured as a hyperlink entitled “Forgot your password” that, when selected, takes the user to a routine for resetting the user's password, and a widget 268 configured as another button that, when selected, takes the user to a routine for creating a new user account. Also, the page 260 includes widgets 270, 272 configured as data entry fields for entering the item to be searched for and the location to search for the item, and widget 273 configured as a selectable button to initiate the search. The search feature can be enabled to act on data entered into fields 270, 272 for users that are not registered with the service.

Returning to FIG. 8A, if the user is a new user and therefore identified as not registered with the service in process step 207, then, as noted above, selecting button 268 takes the user through a routine 208 for creating a new user account. Once registered, or if already registered at step 207, the user proceeds to step 209 and enters their username (which may be an email address) into data field 262 and their password into data field 264, then selects the sign-in button 265 to push the information to the server. Alternatively, the log-in information could be saved by the server and automatically populated on the user device, if the user has chosen that option.

In step 210, the server receives the user's log-in information and runs an authentication routine to verify the information. If the server determines that the log-in information is valid in step 212, then the server generates a search page and sends it to the user device in step 214. If the server determines that the log-in information is not valid in step 212, then the server generates an error message in step 213 and sends the error message to the user device. The user can be asked to re-enter the log-in information in step 215, and if so, the user is returned to step 208 to try again. If not, the routine ends.

The search page generated by the server is delivered to the user in step 214. As shown in FIG. 10, just like the landing page 260 in FIG. 9, the search page 280 includes the data entry fields 270, 272 for entering the item to be searched and the location, and button 273 for initiating the search. In one embodiment, the search page 280 may additionally include data fields 282, 283, 284 for displaying featured items, for example, items that are trending near the user's location or that are being advertised by local merchants who have paid for the ability to advertise on the service.

In one embodiment, in step 216, the user the user enters a search term directed to the item of interest, as well as the location at which the user wants to find the item. For example, the user may enter a food item, such as a burger, or a cannabis item, such as CBD oil, or any other item, as well as a location where the user wants to find the item. In fact, the user can enter terms that may match any field on the database records.

The location may be entered as a very specific location, such as “San Francisco financial district,” or a more general location, such as a zip code. In one embodiment, the location field may be left blank by the user and the location determined by the server (or the user device). In step 218, the information entered by the user into the data fields 270, 272 is received by the server. In step 220, the server determines if the location field was left blank by the user. If so, in step 222, the server automatically detects the user's location, for example, based on the IP address of the user's device, and then proceeds to step 224 (FIG. 8B). If not, the process proceeds directly to step 224.

In step 224 (FIG. 8B), the server proceeds to search the database for the requested item at the desired location. With regard to the location, the server may be programmed to search within a default radius of the location, or alternatively, the user may be provided with an opportunity to set the search radius. For example, the search may be limited by a default setting to a radius of 0.3 miles from the location.

If results for the search terms within the default radius of the location are not found in the database in step 226, then in step 228, the search radius in increased, and the search is run again in step 224. For example, the search radius may initially be set to a default value of 0.3 miles, and increased in 0.3 mile increments until a sufficient number of results are returned by the search.

If results for the search terms within the default radius of the location are found in the database in step 226, then in step 230, the results are formatted for presentation to the user, namely, arranged in descending order according to the number of likes that are associated with the specific item and provided as input to the database by other users. The results may also include a link to obtain further information about the item and/or its location, such as a link to contact information for the location associated with a particular result. In step 232, the results are sent to the user device, and in step 234, the results are displayed on the user device. The results may include a picture of the item.

In step 236, the user can scroll through listed results and select one of the items on the results list, each of which is hyperlinked back to the server. In step 238, when the user has selected one of the results on the results list, the server retrieves further information about the selected item, such as contact information, and sends the information back to the user device, where it is displayed in step 240.

Accessing and Using the System Through a Software Application (“App”) Downloaded to the User's Mobile Device

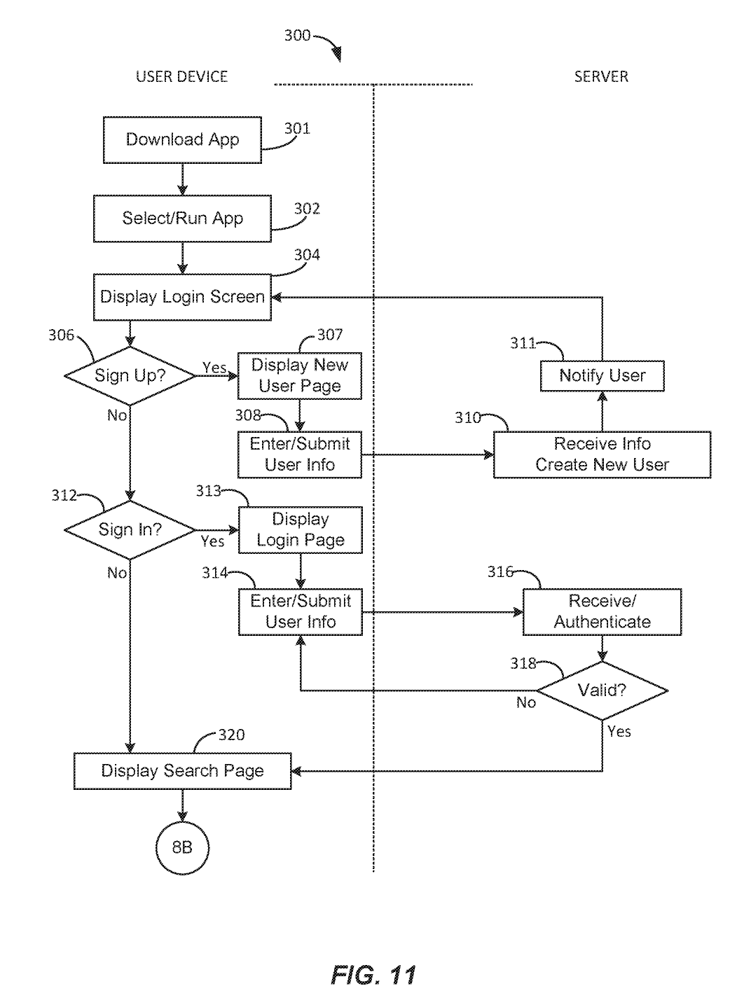

Turning now to FIG. 11, a detailed process 300 is illustrated for accessing the server 50 from a mobile computer-based device, such as smartphone 34, or a laptop or tablet or any other mobile computer-based device. The mobile process 300 is similar to desktop process 200, but rather than hard-wired device connections, the mobile device is connected to the Internet 20 via a wireless connection, for example, through a cellular network, a local WiFi network, or other wireless network. The mobile device may be a conventional computer-based device having its operation managed by an operating system, such as the Apple iOS, Google Android OS, Windows Phone OS, or any other equivalent OS. Further, although some of the process steps must be performed in a certain order, other steps may be performed in a different order.

In step 301, as a preliminary activity, the user navigates to the application store on the user's smartphone (e.g., App Store, iTunes, Google Play, Amazon Appstore, etc.) and downloads an application directed to searching for specific items, as described herein. For example, the user may download the WYMP mobile app, built by the assignee herein, available for download in the App Store, and configured to perform the searching as described herein in a manner similar to the PC version. The mobile search application includes a client portion of software stored on the mobile device that works in conjunction with a server portion of software stored on the server and accessible by the mobile device. Once downloaded, an icon representing the search application is placed on the display of the device, and the application may be selected and run in step 302 by the user simply clicking the application icon on the device display.

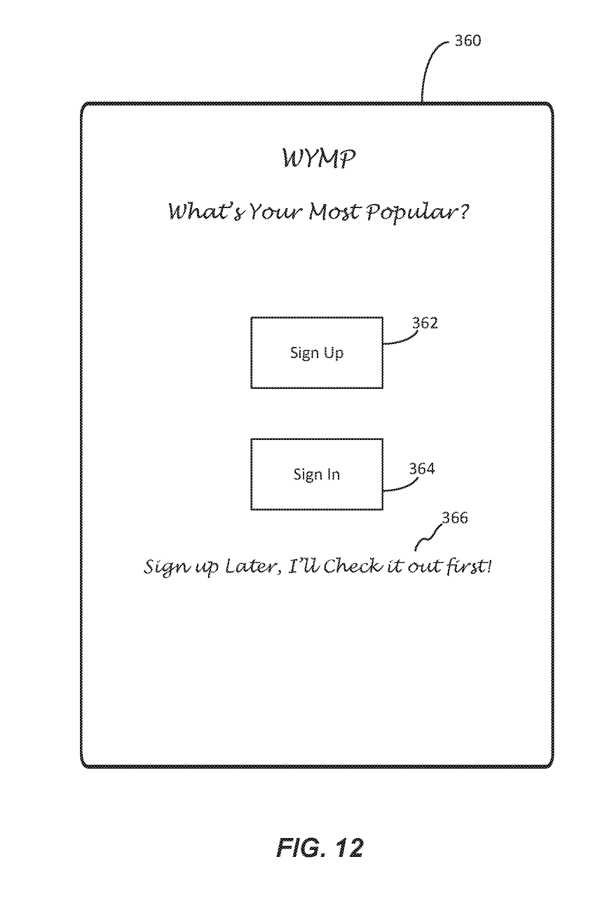

Once the search application is active, in step 304 the application displays a log-in screen 360 as shown in FIG. 12. The log-in screen 360 includes three widgets: a button 362 labeled “Sign Up;” a button 364 labeled “Sign In,” and a hyperlink 366 labeled “Proceed as guest.”

If the user is a new user and wants to register with this service, they will select button 362. If the process 300 detects that button 362 was selected in step 306, then the user will be presented with a screen having data fields to enter a username and a password in step 307. The user then enters the information and submits it to the server in step 308. In step 310, the server receives the user's information and creates a new user account. In step 311, the server notifies the user that the new user account has been created. The user device returns to step 304 and again displays the log-in screen 360.

If, at step 306, the process 300 does not detect that button 362 has been selected, then at step 312, the process determines whether button 364 was selected. If so, then the mobile application displays a log-in screen in step 313 having two data fields for entering username and password and a button for submitting the information. In step 314, the user enters the required information and selects the submit button to send the log-in information to the server.

In step 316, the server receives the user's log-in information and runs an authentication routine. If the server determines that the user's log-in information is valid in step 318, then the process returns to the mobile device, and in step 320, the search page is displayed.

If button 364 is not selected at step 312, then the user proceeds as a guest user to step 320 and the search page is displayed.

When the search page is finally displayed in step 320, the mobile process 300 becomes identical to the process steps 218-240 illustrated in FIG. 8B and the same functionality is incorporated.

In one embodiment, as soon as the user launches the search application on the user's mobile device, the server determines the location of the user's mobile device and generates content to send to the user device for additional display on the search page or an intermediate splash page. The content selected is based on a close proximity to the user's current location. For example, the server may select items that are currently trending in the user's geographical area based on user ratings, or items that are featured as a result of paid advertisements, and these trending or featured items are displayed on the user device, and may be configured as selectable by the user.

Other Features

One of the key features of the search engine application described herein is that results are provided based on peer rankings. To that end, the configuration of the search engine application establishes it as a social media platform as well as a database for particular items, such as food, cannabis, etc. The search engine application can also be integrated with other social media platforms such as Facebook, Instagram, Twitter, etc.

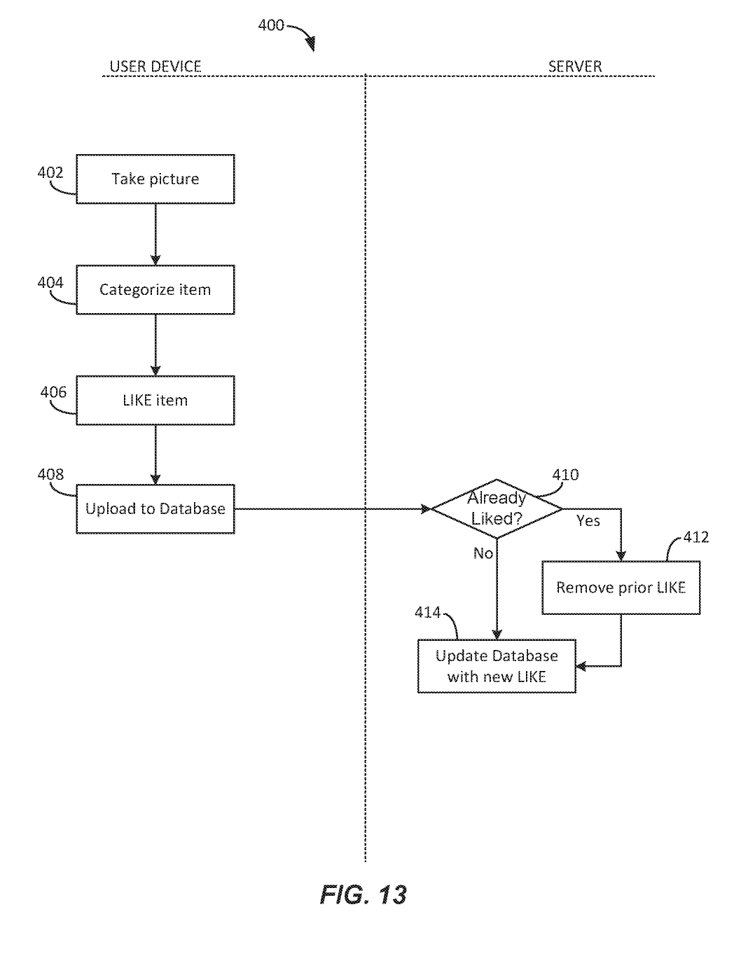

Users are encouraged to take and post pictures of an item while “liking” that item. For example, FIG. 13 illustrates a process 400 for the user to provide a “LIKE” rating for a particular item. In step 402, the user takes a picture of the item, most conveniently using the user's smartphone. In step 404, the user provides a characterization of the item, that is, a description of the item, and a location where the item can be found. For example, the user may provide a single term that describes the item of interest, such as “burger” when searching for a popular food item, or multiple terms, such as “indica flower” when searching for a popular cannabis item. In step 406, the user selects the LIKE widget and submits that rating to the server in step 408.

However, in step 410, if the user has previously submitted a LIKE rating for another item at the same location, the server will remove that prior LIKE of this user in step 412 and update the database with the new LIKE in step 414. The rule is implemented so that users can only LIKE one item per location. If the user has not previously submitted a LIKE rating for another item at the same location in step 410, then the database is immediately updated in step 414.

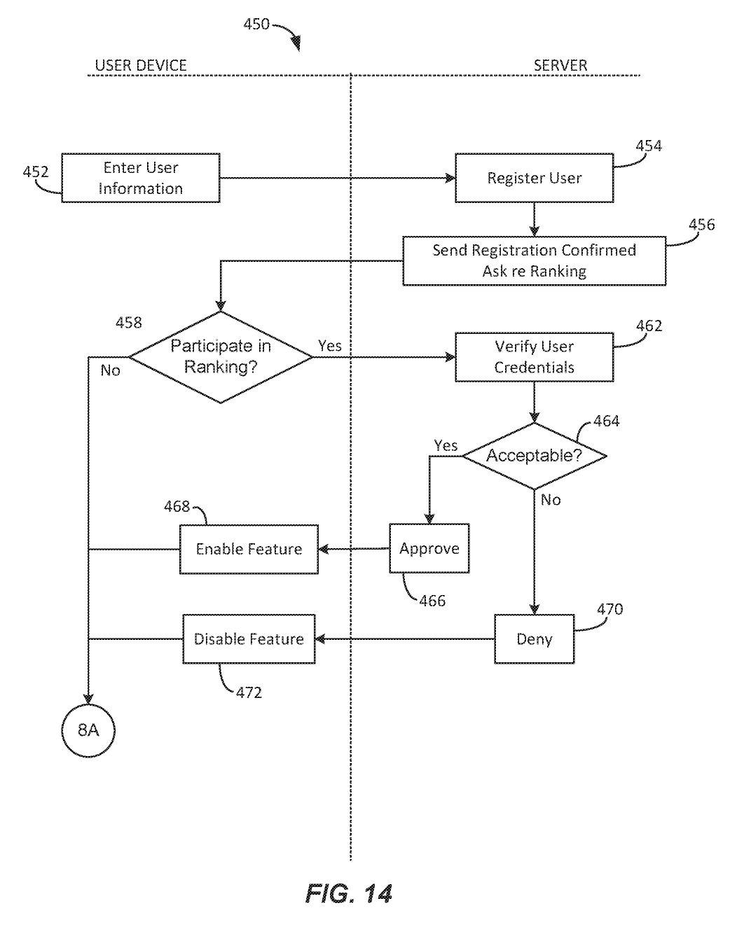

In one embodiment, only registered pre-screened users are allowed to rate items. For example, step 208 of process 100 (see FIG. 8) enables users to create a new user account with the search engine service hosted on the server. Referring now to FIG. 14, a process 450 provides more detail with regard to registering users. In step 452, the user is presented with data entry fields and enters the requested information into the fields, namely, a preferred username and password. In step 454, the server receives the user information and registers the user as a new user account.

In step 456, the server sends a confirmation to the user device indicating that the user has been registered. In addition, the confirmation message includes a question and a link/widget for the user, asked in step 458, as to whether the user wishes to participate is ranking items. If not, then in step 460, the user is returned to step 209 on FIG. 8A to enter log-in information. If the user does wish to participate in ranking items at step 458, then the user responds by selecting the link to continue, and in step 462, the user is presented with one or more questions intended to verify that the person is actually a person and is qualified to rank items. For example, a threshold question for someone to rank cannabis items or alcoholic drinks is whether the person is 21 years old (in many states) and therefore legally entitled to drink alcohol or purchase cannabis. If the user passes the verification question(s) in step 464, then the server approves the user's request in step 466, enables the ranking feature for this user in step 468, then returns to step 209 of process 200 (see FIG. 8A). If the user does not pass the verification question(s) in step 464, then the server denies the request in step 470, disables the ranking feature for this user in step 472, and sends notification to the user in step 474.

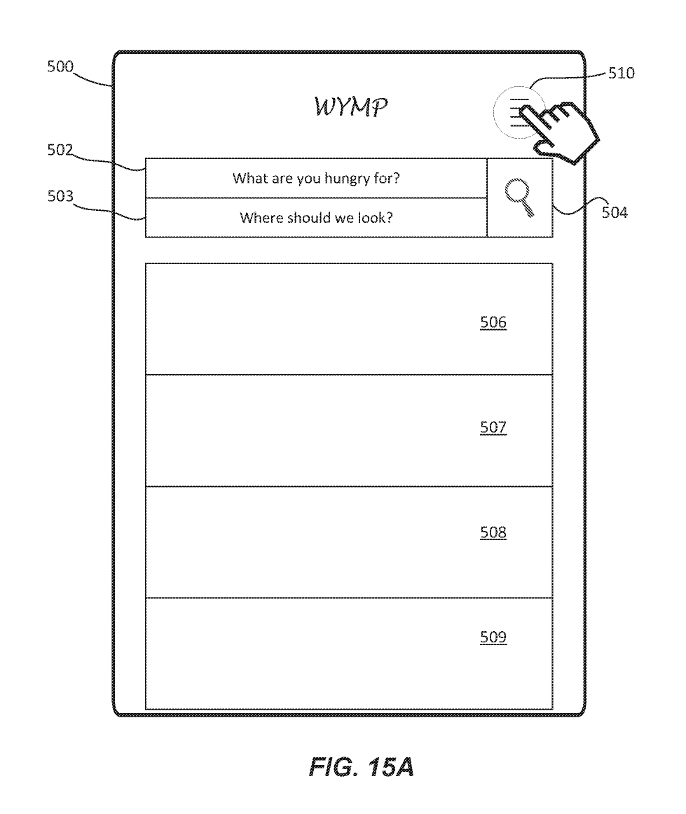

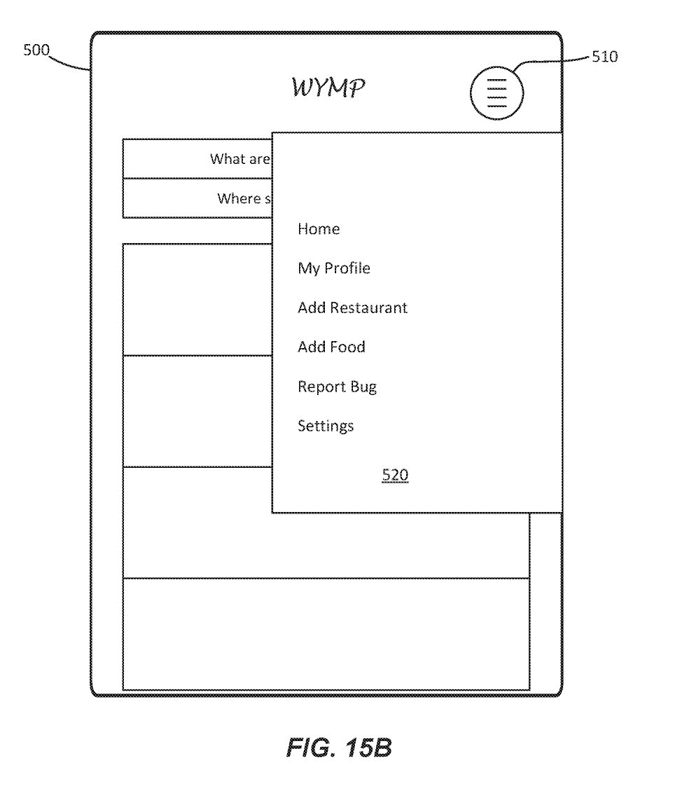

Another key feature of the search engine application is that the database is populated by users. For example, the application is configured so that users can add items and/or retail locations that sell the items. Referring to FIG. 15, the display on a user device 500 includes search field 502, location field 503, and search button 504, as well as featured or advertised items 506, 507, 508, 509. In addition, the display includes widget 510 configured as a selectable button. When the button 510 is selected by the user, an options menu 520 pops up over the search page, as shown in FIG. 15B. The options listed on menu 520 are hyperlinks that take the user to other pages. Of particular interest here are hyperlink 522 labeled “Add Restaurant” and hyperlink 524 labeled “Add Food.”

If link 522 is selected, the user is asked to fill out and submit a form providing the details of the restaurant. The system will add the restaurant to its database.

If link 524 is selected, the user is presented with a data entry field and asked to search for a restaurant. The user enters the restaurant name and submits a search request. If the restaurant is already present in the database, the user will be able to scroll through the food item choices offered at that restaurant and select the food of interest. If the restaurant is not yet in the database, the user will be directed to the add restaurant routine described above.

User accounts may be configured with other features as well. For example, a user may opt to follow one or more specific users, or to follow user(s) that have the same “tastes” in particular items, such as food, cannabis, etc.

Users may also be provided with incentives or rewards for sharing or ranking items, or referring users, or recommending items or locations, and other valuable incentives, including coupons or discounts. Users may be provided with a profile screen or a dashboard that summarizes their recent or historical use of the search engine.

It should be understood that the foregoing description is exemplary only, and that modifications may be made without departing from the spirit and scope of the disclosure.

1. A method, comprising:
receiving, by a server from a first application executing on a user device, a request to search for retail availability of a specific cannabis item;
identifying, by the server, a location and a range from the location;
searching, by the server, for the requested specific cannabis item within the range of the location in a database storing data records for a plurality of cannabis items, the data records having been populated to the database by users of the first application, and each data record including, for each cannabis item, a unique identifier for the cannabis item, a type of the cannabis item, a sub-type of the cannabis item, a description of the cannabis item, a retail outlet where the cannabis item is available for purchase, and a likes value representing a number of likes posted by other users for the cannabis item at the retail outlet;
generating, by the server, search results as a list of retail outlets ranked in descending order by the number of likes for the specific cannabis item at different retail outlets, each of the search results being selectable as a link to provide further information regarding the selected search result; and
transmitting the ordered search results from the server to the user device.

2. The method of claim 1, wherein the identified location is determined by the server based on data associated with the user device.

3. The method of claim 1, wherein the identified location is received from the user device.

4. The method of claim 2, wherein the identified location is determined by the server geolocation data when the user opens the first application.

5. The method of claim 2, wherein the identified location is determined by the server from an internet protocol address of the user device.

6. The method of claim 1, the searching step further comprising:
increasing the range from the location when the searching step generates no results.

7. The method of claim 1, further comprising:
receiving, by the server, a like post from a user for a particular cannabis item at a particular retail outlet;
when the server has received a prior like post from the user for the particular retail outlet, removing the prior like post from the database; and
updating the database to add the like post to the data record for the particular cannabis item at the particular retail outlet.

8. The method of claim 7, further comprising:
receiving, by the server from the user device, an image of the particular cannabis item at the particular retail outlet;
categorizing the particular cannabis item; and
updating the database to add a data record for the particular cannabis item at the particular retail outlet.

9. The method of claim 8, wherein the step of categorizing comprises adding the type of the particular cannabis item, the sub-type of the particular cannabis item, or the description of the particular cannabis item.

10. The method of claim 1, the further information included on the data record for the particular cannabis item provides contact information for the particular retail outlet.

11. The method of claim 10, the contact information including an address and directions for the particular retail outlet.

12. The method of claim 1, further comprising:
generating, by the server, a listing of featured cannabis items available proximate to the identified location, each of the featured items being selectable as a link to provide further information regarding the selected featured item; and
transmitting the listing of featured items from the server to the user device for display on the user device prior to displaying search results.

13. The method of claim 7, further comprising authorizing the user to post likes for cannabis items.

14. A computer program product, comprising a non-transitory computer-readable medium containing one or more sequences of instructions executable by a processor in a computer, wherein the instructions, when executed by the processor, cause the processor to:
receive from a first application executing on a user device, a request to search for retail availability of a specific cannabis item;
identify a location and a range from the location;
search for the requested specific cannabis item within the range of the location in a database storing data records for a plurality of cannabis items, the data records having been populated to the database by users of the first application, and each data record including, for each cannabis item, a unique identifier for the cannabis item, a type of the cannabis item, a sub-type of the cannabis item, a description of the cannabis item, a retail outlet where the cannabis item is available for purchase, and a likes value representing a number of likes posted by other users for the cannabis item at the retail outlet;
generate search results as a list of retail outlets ranked in descending order by the number of likes for the specific cannabis item at different retail outlets, each of the search results being selectable as a link to provide further information regarding the selected search result; and
transmit the ordered search results to the user device.

15. A method, comprising:
receiving, by a server from a first application executing on a user device, a request to search for retail availability of a specific item;
identifying, by the server, a location and a range from the location;
searching, by the server, for the requested specific item within the range of the location in a database storing data records for a plurality of items, the data records having been populated to the database by users of the first application, and each data record including, for each item, a unique identifier for the item, a type of the item, a sub-type of the item, a description of the item, a retail outlet where the item is available for purchase, and a likes value representing a number of likes posted by other users for the item at the retail outlet;
generating, by the server, search results as a list of retail outlets ranked in descending order by the number of likes for the specific item at different retail outlets, each of the search results being selectable as a link to provide further information regarding the selected search result; and
transmitting the ordered search results from the server to the user device.
